(19) United States
(12) Patent Application Publication
(10) Pub. No.: US 2003/0066955 A1
(43) Pub. Date: Apr. 10, 2003

(54) Integrated field flattener for sensors

(76) Inventors: Michael P. Schaub, Tucson, AZ (US); Henry J. Kreis, Tucson, AZ (US)

Correspondence Address: David W. Collins, Suite 125B, 75 W. Calle de las Tiendas, Green Valley, AZ, 85614, US

(21) Appl. No.: 09/974,062

(22) Filed: Oct. 9, 2001

(51) Int. Cl. H01J 5/02; H01J 40/14

(52) U.S. Cl. 250/239

(57) ABSTRACT

An integrated circuit package including an optical sensor array is provided with a transparent window comprising a thermoset plastic, such as an epoxy transfer clear molding compound, that is resistant to the elevated temperatures found in semiconductor processing and is configured as a lens, to improve the image quality of the image incident on the sensor. As an example, a field flattener lens is incorporated into the window to form an integral element that also acts as an hermetic seal. Thus, the field flattener is made integral with the sensor. The thermoset lens provides two functions: (1) it improves the image quality; and (2) it protects the sensor from damage and contamination. This protection is normally provided by a glass window on the sensor, but is no longer necessary by virtue of the present invention.

### TECHNICAL FIELD

The present invention is directed generally to field flatteners for improving the image quality of lenses, and, more particularly, to field flatteners integral with a sensor.

### BACKGROUND ART

Solid-state optical sensors find a variety of uses, such as in video cameras, digital still cameras, desktop scanners, bar-code readers, security scanners, and the like. Such devices ordinarily comprise a lens or other image-forming element capable of capturing the light from a scene or subject and focusing or projecting the light onto a surface that is capable of sensing the light. This surface typically comprises an array of tiny sensor elements, such as charge-coupled-devices (CCDs) or complementary metal oxide semiconductor (CMOS) photoreceptors.

These sensors typically comprise planar, rectangular matrices, or arrays, of photoelectric transducer elements fabricated on the surface of semiconductor substrates, typically silicon, by known photolithographic techniques, that are capable of converting the light energy incident upon them into electrical signals on an element-by-element, or pixel-by-pixel, basis. These signals, usually digital in nature, include information pertaining to, for example, the intensity, color, hue, saturation, and other attributes of the incident light.

The sensor array substrates are typically individually packaged in an hermetically sealed package having signal input/output terminals and a clear glass or plastic lid, or window, that exposes the light-sensitive elements of the sensor below it to the incident light. Examples of such packages are disclosed in U.S. Pat. No. 6,117,193, entitled “Optical Sensor Array Mounting and Alignment” and issued on Sep. 12, 2000, to Thomas P. Glenn and in U.S. Pat. No. 7,117,705, entitled “Method of Making Integrated Circuit Package Having Adhesive Bead Supporting Planar Lid Above Planar Substrate” and issued on Sep. 12, 2000, to Thomas P. Glenn et al.

In U.S. Pat. No. 6,117,193, the transparent window may comprise glass, quartz, diamond, sapphire, or a clear, hard plastic, such as an acrylic. If the window is secured to the semiconductor package prior to subsequent exposure to elevated temperatures, such as experienced in solder re-flow operations, then use of a plastic such as an acrylic for the window would subject this thermoplastic material to possible distortions from the heat. Thus, while a material such as glass, quartz, diamond, sapphire, or the like might be suitable as the transparent window, it is clear that the use of thermoplastic materials is contraindicated.

The image quality of the lenses used with CMOS packaging is typically controlled by the number of lens elements in the design. Additional elements will typically provide improved image quality, but will increase the cost, size, and weight of the lens assembly.

Thus, there is a need for a reconfigured CMOS (or CCD) package that employs a transparent window that will also correct aberrations of the lens while not adding weight or bulk to the overall package.

### DISCLOSURE OF INVENTION

In accordance with the present invention, an integrated circuit package including an optical sensor array is provided with a transparent window comprising a plastic that is resistant to the elevated temperatures found in semiconductor processing, such as found in subsequent solder re-flow to attach the package to a microelectronics board, and is configured as a lens, to improve the image quality of the image incident on the sensor. In particular, a thermoset plastic material, such as an epoxy transfer clear molding compound, is employed as the lens.

In one preferred embodiment, a field flattener lens is incorporated into the window to form an integral element that also acts as an hermetic seal. Thus, the field flattener is made integral with the sensor.

The thermoset lens provides two functions: (1) it improves the image quality; and (2) it protects the sensor from damage and contamination. This protection is normally provided by a glass window on the sensor, but is no longer necessary by virtue of the present invention, in which the thermoset lens (e.g., field flattener) replaces the glass window.

Other objects, features, and advantages of the present invention will become apparent upon consideration of the following detailed descript and accompanying drawings, in which like reference designations represent like features throughout the FIGURES.

### BRIEF DESCRIPTION OF THE DRAWINGS

The drawings referred to in this description should be understood as not being drawn to scale except if specifically noted.

FIG. 1 is a cross-sectional view, depicting an hermetically-sealed package containing a die, such as a CMOS or CCD sensor, sealed with an integral field flattener and transparent window; and

FIG. 2 is a view similar to that of FIG. 1, but also showing an exploded view of an embodiment of the present invention directed to alignment/mounting features of the field flattener with a lens assembly.

### BEST MODES FOR CARRYING OUT THE INVENTION

Reference is now made in detail to a specific embodiment of the present invention, which illustrates the best mode presently contemplated by the inventors for practicing the invention. Alternative embodiments are also briefly described as applicable.

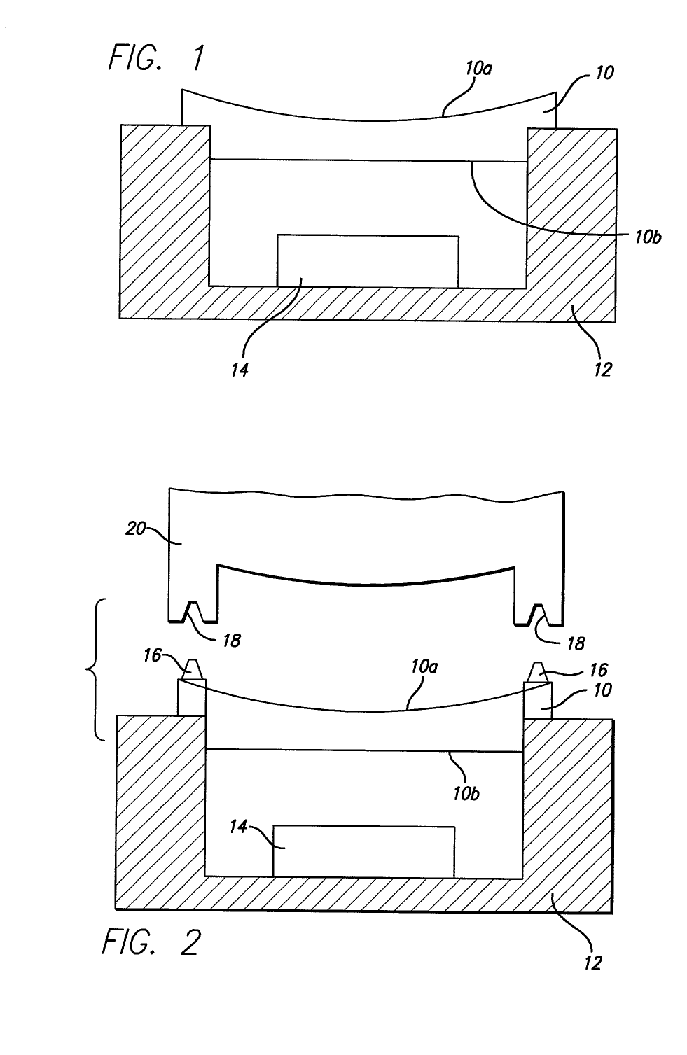

In a specific embodiment, depicted in FIG. 1, the present invention consists of a field flattening lens 10, usually a negative power lens, which is integral with a sensor package 12 containing a die 14. The die 14 is commonly a sensor, such as a CMOS (complementary metal oxide semiconductor) or CCD (charge coupled device). Such sensors are well-known, and do not form a part of the present invention.

Field flatteners are used to improve the image quality of lenses. They are usually part of the lens system. The field flattener 10 of the present invention replaces the glass cover plate that is typically used to protect the sensor 14 from damage and contamination.

The field flattening lens 10 of the present invention operates by introducing the correct amount of field curvature to balance that of a lens positioned in front of it. Although shown in FIG. 1 wherein one surface 10a is curved and the opposite surface 10b is flat, the field flattening lens 10 may have one or two spherical, aspherical, or diffractive surfaces. The lens 10 may also have hybrid surfaces consisting of diffractive and/or refractive microlenses or antialiasing features.

The field flattener 10 may also provide other functions, such as mechanical alignment. Alignment features or mounting features may be integral with the field flattening lens. For example, as shown in FIG. 2, bumps or cones 16 could be molded into the edges of the field flattener 10. These would interface, or mate, with similar, receptive, features 18 on a lens assembly 20 to provide alignment. These features 16, 18 could provide centration and tilt alignment of the lens assembly 20 to the field flattener 10. Of course, the features could be reversed, with the bumps or cones 16 on the lens assembly 20 and the receptive features 18 on the field flattener 10.

The lens 10 of the present invention comprises a transparent thermoset plastic, such as an epoxy transfer clear molding compound. An example of such compounds is available from Nitto Denko America, Inc. (Fremont, Calif.) under the trade designation NT-300 and NT-301H. These compounds are self-releasing, fast cure, transparent epoxy resins.

The lens 10 is formed by a thermoset molding process, advantageously using pellets as the starting material. Specifically, individual components are formed into pellets and then react when exposed to high temperatures on the order of 145° to 160° C. (recommended mold condition). The maximum reaction temperature (for use as an optical element) is less than 165° C.; this is the temperature at which the resin becomes cloudy, thereby adversely affecting the optical transmission of the molded lens. A post-mold curing time of 2 hours is required, and the molded piece will yellow during curing if the oven conditions (curing time and a constant curing temperature in the range of 150° to 160° C.) are not appropriately controlled. The molded lens is then cooled to ambient temperature, such as room temperature (e.g., about 23° C.).

The pellets are heated up in a mold above a certain temperature, where a chemical reaction occurs to form the thermoset plastic. Once the chemical reaction occurs, the thermoset plastic lens 10 will not melt at any temperature, but rather will burn at some elevated temperature. The temperature of burning is typically higher than the melting temperature of a thermoplastic material and is also higher than the temperatures to which the die 14 and package 12 may be subjected to in subsequent processing.

Other optically transparent thermosetting compounds are known; see, e.g., U.S. Pat. No. 5,548,675 (optically transparent ferrule: epoxy resin) and U.S. Pat. No. 5,880,800 (optically transparent protective film: acrylic, urethane, acrylurethan, epoxy, and silicone resins). To the extent that these additional thermoset resins are moldable into lenses 10 of the present invention and retain the requisite optical transparency following molding, they are also useful in the practice of the present invention. Of course, lenses molded from such thermosetting compounds must be thermally resistant to the temperatures commonly found in subsequent semiconductor processing.

### INDUSTRIAL APPLICABILITY

The thermoset lens of the present invention is expected to find use in hermetically sealing sensor packages.

Thus, there has been disclosed a thermoset lens, such as a field flattener, integrated with an hermetically-sealed sensor package. It will be readily apparent to those skilled in this art that various changes and modifications of an obvious nature may be made, and all such changes and modifications are considered to fall within the scope of the present invention, as defined by the appended claims.

What is claimed is:

1. In combination, a package containing a sensor die and an optically transparent window for permitting electromagnetic radiation to be sensed by said sensor die and for providing an hermetic seal to said package to protect said sensor die against damage and contamination, wherein said optically transparent window includes an optically transparent thermoset plastic lens.

2. The combination of claim 1 wherein said package is a ceramic package.

3. The combination of claim 1 wherein said thermoset plastic lens comprises an optically transparent epoxy.

4. The combination of claim 3 wherein said epoxy is a self-releasing and fast cure resin.

5. The combination of claim 1 wherein said optically transparent window and said optically transparent thermoset plastic lens are an integral unit.

6. The combination of claim 1 wherein said optically transparent thermoplastic lens is a field flattener.

7. The combination of claim 6 wherein said field flattener has two opposed major surfaces, each independently selected from spherical surfaces, aspheric surfaces, diffractive surfaces, and combinations thereof.

8. The combination of claim 1 wherein said optically transparent thermoplastic lens includes an anti-aliasing surface.

9. The combination of claim 1 wherein said optically transparent thermoplastic lens includes an aberration-correcting surface.

10. The combination of claim 1 wherein said optically transparent thermoplastic lens includes alignment features for alignment with a lens assembly.

11. The combination of claim 10 wherein said alignment features comprise bumps or cones molded into edges of said optically transparent thermoplastic lens, for alignment with mating features on said lens assembly.

12. A method for providing an hermetic seal to a package containing a sensor die to protect said sensor die against damage and contamination and for permitting electromagnetic radiation to be sensed by said sensor die through an optically transparent window, said method comprising:
(a) providing an optically transparent thermoset plastic lens as part of said optically transparent window; and
(b) securing said optically transparent thermoset plastic lens and said optically transparent window to said package.

13. The method of claim 12 wherein said thermoset plastic lens comprises an optically transparent epoxy.

14. The method of claim 13 wherein said epoxy is a self-releasing and fast cure resin.

15. The method of claim 12 wherein said optically transparent window and said optically transparent thermoset plastic lens are formed as an integral unit.

16. The method of claim 12 wherein said optically transparent thermoplastic lens is a field flattener.

17. The method of claim 16 wherein said field flattener has two opposed major surfaces, each independently selected from spherical surfaces, aspheric surfaces, diffractive surfaces, and combinations thereof.

18. The method of claim 12 wherein said optically transparent thermoplastic lens includes an anti-aliasing surface.

19. The method of claim 12 wherein said optically transparent thermoplastic lens includes an aberration-correcting surface.

20. The method of claim 12 wherein said optically transparent thermoplastic lens includes alignment features for alignment with a lens assembly.

21. The method of claim 20 wherein said alignment features comprise bumps or cones molded into edges of said optically transparent thermoplastic lens, for alignment with mating features on said lens assembly.

22. A method for forming a transparent epoxy thermoset lens comprising:
(a) providing pellets containing reactive components to form said epoxy;
(b) placing said pellets in a lens mold;
(c) subjecting said pellets in said mold to a temperature within a range of about 145° to 160° C. to form said lens;
(d) subjecting said lens to a post-mold curing time and temperature within a range of 150° to 160° C.; and
(e) cooling said lens to ambient temperature.

23. The method of claim 22 wherein said post-mold curing time is 2 hours.
